(19) United States
(12) Patent Application Publication
(10) Pub. No.: US 2019/0352808 A1
(43) Pub. Date: Nov. 21, 2019

(54) ELECTRONICALLY FUNCTIONAL YARN AND TEXTILE

(71) Applicant: Microsoft Technology Licensing, LLC, Redmond, WA (US)

(72) Inventors: Sang Ho YOON, Redmond, WA (US); Kelly Marie BOGAN, Redmond, WA (US); James David HOLBERY, Bellevue, WA (US); Siyuan MA, Bothell, WA (US)

(73) Assignee: Microsoft Technology Licensing, LLC, Redmond, WA (US)

(21) Appl. No.: 15/982,298

(22) Filed: May 17, 2018

(51) Int. Cl. D02G 3/44; D02G 3/36; A41D 1/00

(52) U.S. Cl. CPC D02G 3/441; G06F 3/014; A41D 1/005; D02G 3/36

(57) ABSTRACT

Examples are disclosed that relate to integrating electronic functionality into textiles. One example provides an article including a textile, a fabric piping positioned along the textile, an electrical conductor positioned within an interior of the fabric piping, and a first electronic component and a second electronic component disposed on the article and electrically connected by the electrical conductor.

### BACKGROUND

Textiles may be formed from yarn segments joined together by weaving, knitting, and/or other methods. A yarn may be formed from filaments or fibers that are spun together to form a continuous strand. Some yarns may have a core-sheath structure in which a central core is surrounded by a sheath formed either from a same or different material as the sheath.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to integrating electronic functionality into textiles. One disclosed example provides an article including a textile, a fabric piping positioned along the textile, an electrical conductor positioned within an interior of the fabric piping, and a first electronic component and a second electronic component disposed on the article and electrically connected by the electrical conductor.

Another example provides an article comprising a textile, a first electronic component and a second electronic component coupled with the article, and a yarn structure electrically connected to the first electronic component and the second electronic component. The yarn structure comprises a first core/sheath yarn comprising a first plurality of conductive wires within a core of the first core/sheath yarn, and a second core/sheath yarn comprising a second plurality of conductive wires within a core of the second core/sheath yarn.

### BRIEF DESCRIPTION OF THE DRAWINGS

FIG. 1 shows a use scenario for an example textile device.

FIGS. 2A-2B show the textile device of FIG. 1.

FIG. 3 shows another example textile device.

FIG. 4 shows another example textile device.

FIG. 5 shows an example electrically conductive core/sheath yarn structure.

FIG. 6 shows an example fabric piping.

FIG. 7 shows an example force-directing structure to distribute a pulling force applied to an electronically functional textile article.

FIG. 8 shows an example textile article in the form of a chair.

### DETAILED DESCRIPTION

Electronic components may be incorporated into a textile article to form an electronically functional textile article. An electronically functional textile article may include any suitable electronic circuit elements. Examples include input devices (e.g. an optical sensor, a capacitive sensor, a resistive sensor, an acoustic sensor, a pressure sensor, a temperature sensor, and a chemical sensor (e.g., for sensing gases such as NOₓ, CO₂, and/orO₂)), output devices (e.g. light-emitting diodes (LEDs) and haptic actuating devices (e.g. a vibro-motor or other actuator)), and also other circuitry, such as an antenna for transmitting and/or receiving data, control circuitry such as a memory component and processing component (e.g., a microprocessor configured to execute applications), and power supply circuitry (e.g. one or more batteries, one or more solar cells, etc.).

However, integrating electronic functionality into a textile article poses various challenges. For example, many textile articles are configured to naturally flex or deform during use for comfort, such as clothing or furniture upholstery. In view of this, conductors used to connect electronic components at different locations on the articles may be subject to bending, pulling, and other stresses repeatedly during a device lifetime. To avoid breakage, relatively thicker conductors may be used. However, such conductors (e.g. copper wire) may feel stiff and unnatural, and thus impact a user experience. Alternatively or additionally, an electrical conductor may be embroidered in a serpentine pattern on the textile to accommodate elongation of the textile. However, such trace patterns may crowd the textile and increase a rigidity of the textile, and further may be susceptible to failure from breakage. Additionally, it may be difficult to integrate such conductors into a textile article in a visually pleasing manner.

Accordingly, examples are disclosed that relate to integrating thin, flexible, and robust electrical conductors into textile articles to connect electronic components that are also integrated into the articles. Briefly, an electrically conductive yarn may comprise a core having a plurality of thin, flexible electrical conductors surrounded by a sheath material. Two or more such yarns may be twisted or otherwise joined into a combined structure for redundancy and structural support. Such conductors, or any other suitable conductors, may be integrated into a textile via a decorative fabric piping that serves as a conduit for the electrically conductive yarn. Such a fabric piping also may store some excess yarn length to provide sufficient “slack” between electronic components to improve durability and thereby help to maintain a conductive path as the textile is bent, stretched, and/or rotated.

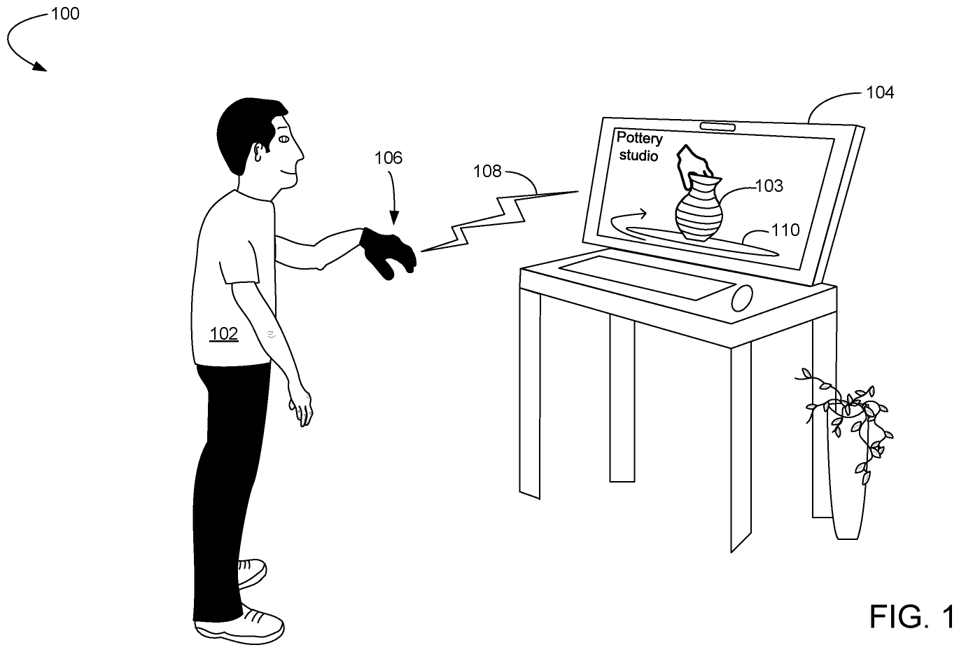

Prior to discussing these examples, FIG. 1 depicts an example use scenario 100 in which a user 102 is forming a virtual clay vase 103 via a virtual pottery studio application executed by a computing device 104. User 102 is wearing an input device in the form of a glove-like textile device 106 communicatively coupled to the computing device 104, wherein the textile device 106 comprises joint motion sensors and other suitable sensors configured to sense hand and finger movements, postures and/or orientations and provide signals derived from such sensing to computing deice 104 as user input. In the example of FIG. 1, the textile device 106 is communicatively coupled to the computing device 104 via a wireless connection 108. In other examples, a wearable device or other textile device may communicate with a computing device via a wired connection. While depicted as being used to control an application on a desktop computer 104, a wearable input device such as the textile device 106 may be used to interact with any suitable computing device, including head-mounted computing devices (virtual reality, augmented reality, or mixed reality), other wearable devices, game consoles, laptops, tablets, as well as other machinery/equipment (e.g. industrial machinery, healthcare-related equipment, vehicles, etc.).

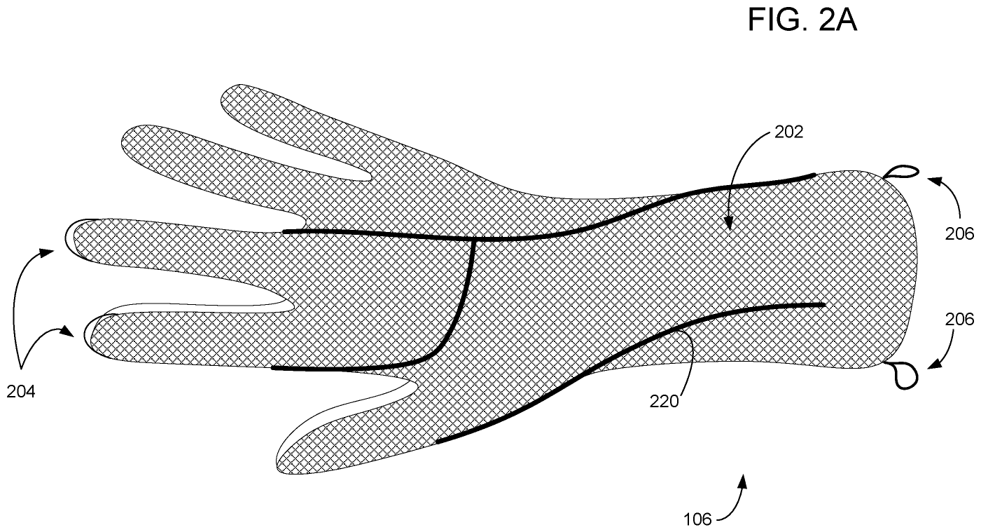

FIGS. 2A and 2B depict the textile device 106 in more detail. While shown as a five-finger glove for providing input via movement of all five fingers, in other examples a glove input device may include sensing capabilities for fewer than five fingers (e.g., thumb, index finger and middle finger in one specific example). The textile device 106 comprises a layered fabric structure having an outer fabric layer 202, shown in FIG. 2A, and an inner fabric layer 203, shown in FIG. 2B. Electronic components of the textile 106 may be concealed between the outer fabric layer 202 and the inner fabric layer 203 so that they are not noticeable, protected from damage, and kept separate from a person's skin. The textile device 106, in this example, is configured to flex and move with a similar feel as a conventional, non-electronically functional glove, to provide a user input mechanism that feels natural and unobtrusive. The outer and inner fabric layers 202, 203 may be formed from any suitable textile material or materials, including natural textile materials, synthetic textile materials, and blended textile materials. FIG. 2A also depicts string hook(s) 204 and 206, respectively, for pulling the glove off of or onto a hand. In some examples, the string hooks each may be connected to an internal structural framework that distributes the pulling force across a relatively wide area of the textile device between textile layers. As explained in more detail below, this may help to prevent damaging electrical connections between components of the textile device when the device is pulled. While described in reference to a glove-like input device in the examples of FIGS. 1, 2A, 2B, and 7, a textile device may comprise any other suitable form.

FIG. 2B depicts the textile device 106 with the outer layer 202 removed, and shows a plurality of motion sensors 208 coupled to the inner layer 203 wherein each motion sensor 208 is positioned to be located over a knuckle of a finger when the textile device 106 is worn. The sensors of FIG. 2B are shown for example, and a wearable device (or other textile device) may include any suitable number of, type of, and placement of sensors for sensing motion, pressure, and/or other variables.

In some examples, a textile device also may include various output devices. In the example of FIG. 1, haptic devices may be positioned near the fingertips and/or at other locations to provide feedback based upon interactions with a displayed virtual object (e.g. when the virtual spinning clay vase 103 of FIG. 1 is intersected by a virtual hand controlled via glove 106). Any suitable haptic device(s) may be used. Example haptic devices include, but are not limited to, linear resonant actuator (LRA) motors, eccentric rotating mass (ERM) motors, voice coil actuators, and soft actuators.

Continuing with FIG. 2B, the textile device 106 may include an inertial measurement unit (IMU) 212 for sensing changes in hand position and orientation. The IMU 212 may include an accelerometer, a magnetometer, and/or a gyroscope. In this example, the IMU 212 is disposed on a backside of the hand of the textile device 106, which may help to provide an accurate estimate of an overall hand orientation. In other examples, an IMU (when included) may be positioned in any other suitable location.

The textile device 106 further may include one or more light-emitting diodes (LEDs) 214. In the example of FIG. 2B, an array of LEDs 214 is configured to emit light detectable through the outer fabric layer 202 of the textile device 106. In other examples, the LEDs may be integrated into a yarn (e.g. by use of a core-sheath type yarn with a core comprising a flexible substrate having printed or etched electrical traces to which the LEDs are attached). LEDs 214 may be used to provide visual notifications to a user, for optical tracking via a machine vision system external to the textile device (e.g. on a head-mounted device or a stationary device in the use environment), and/or for any other suitable use.

The plurality of components disposed on the textile device 106 are electrically connected to a circuit board 216 (e.g. a controller board) via segments of electrically conductive yarn 218. Any suitable electronically conductive yarn structure may be used. Suitable electronically conductive yarn structures include structures that are flexible and do not unduly restrict movement of the fabric of the textile device, and that are resistant to damage as the textile device is removed from the body. As one example, each segment of electronically conductive yarn may comprise a core/sheath yarn structure containing multiple thin strands of metallic conductive wire. The use of multiple conductive strands may help to improve the strength and current carrying capacity of the yarn while maintaining greater flexibility than provided by a lesser number of thicker conductive wires. One example of such a conductive yarn is described in more detail below. The segments of conductive yarn may be connected to the electronic components in any suitable manner. For example, as shown in FIG. 2B, a thermoplastic adhesive 222, such as a polyurethane adhesive, may be used to fix the electrically conductive yarn to a contact on an electronic component and cover a region around the contact. Such an adhesive may provide for a robust yet flexible connection, and may be used at locations subject to bending and/or twisting during ordinary use. Other examples include anisotropically conductive film pastes and flexible flat cable (FCC)-type connection.

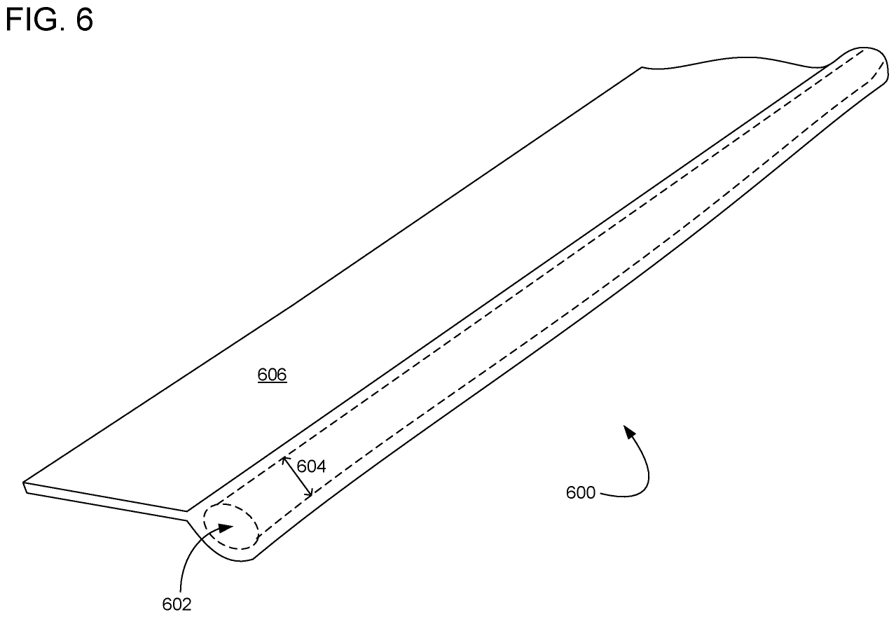

Routing a thin conductive yarn segment between the outer fabric layer 202 and the inner fabric layer 203 may pose challenges. For example, where the wire is allowed to rest loosely between the two fabric layers, the wire may not stay in a desired place, but rather may move to undesired locations. Such movement also may subject the wires to damage as the glove is pulled and moved. Thus, to avoid such issues, in the example of FIGS. 2A-2B each electrically conductive yarn 218 is positioned within a fabric piping 220 joined to the textile device 106. This protects the yarn in a manner that also adds a visually appealing fashion element to the textile product. An example fabric piping is described in more detail below in regard to FIG. 6.

The circuit board 216 may have any suitable construction. In some examples, the circuit board 216 may comprise a flexible substrate and may be configured to flex with movement of the textile device 106. In other examples, the circuit board 216 may have a more rigid structure and be positioned away from any joints of the hand or wrist. The circuit board 216 may be coupled to the fabric of the textile device 106 in any suitable manner. For example, the circuit board 216 may be adhered to or otherwise coupled to a fabric, polymer or composite structure that can be sewn into the textile device 106 or adhered to the textile device 106.

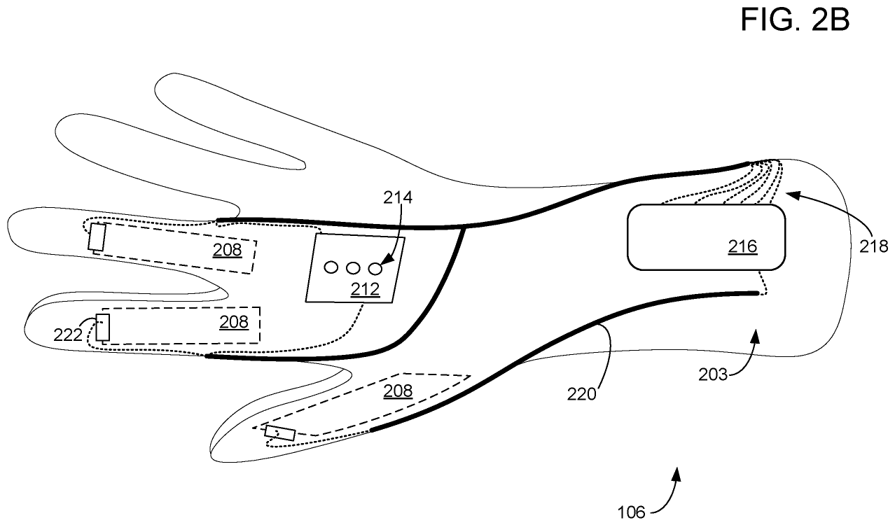

FIG. 3 depicts another example textile device 300 in the form of an electronically functional shirt configured to provide inputs to and outputs from a computing device. Textile article 300 includes motion sensors 302 positioned at locations corresponding to an elbow and a shoulder to sense motion of the corresponding elbow and shoulder joints. Shirt 300 further includes a touch sensor 308 for making user inputs to a computing device. Each sensor 302, 308 of the textile article 300 is connected to a circuit board 308 via an electrically conductive yarn 310 positioned within a fabric piping 312. In this example, each segment of piping 312 extends beyond the locations at which each electrically conductive yarn 310 exits the piping to give the textile article 300 a desired ornamental appearance. In other examples, shirt 300 may include any other suitable input devices and output devices.

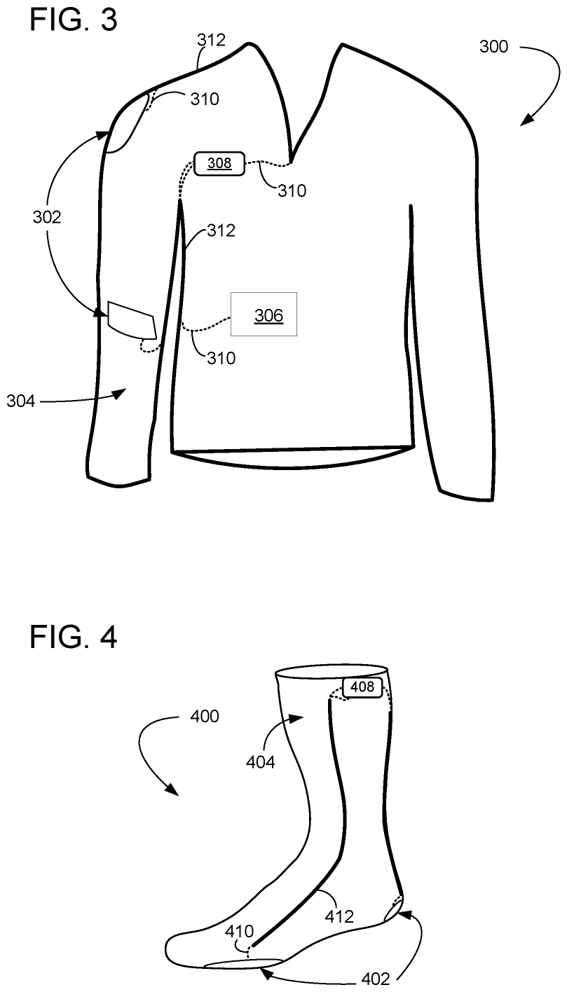

FIG. 4 depicts another example textile device 400 in the form of an electronically functional sock. Textile device 400 includes a pressure sensor 402 located at positions corresponding to a heel and a ball of a foot. Each sensor 402 is connected to a circuit board 408 via electrically conductive yarn 410 positioned within a fabric piping 412. In the example of a sock, the piping may be configured to have a low profile, small diameter, and a placement to avoid substantially impacting comfort (e.g. when the sock is worn inside of a shoe). It will be understood that the pressure sensors of FIG. 4 are presented for example, and that an electronically functional sock may include any suitable electronic components.

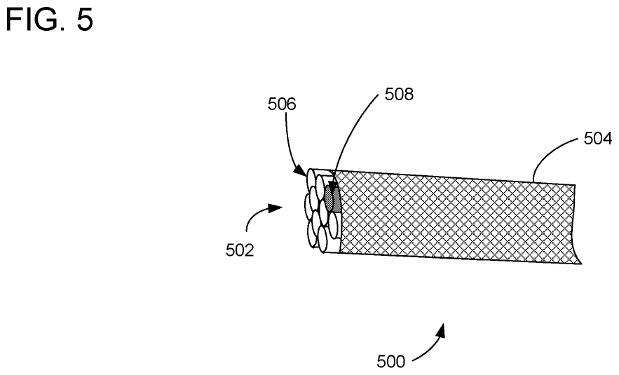

FIG. 5 shows an example electrically conductive yarn in the form of a core/sheath yarn structure 500 having an electrically conductive core 502 and an electrically insulating sheath 504. The sheath 504 of the yarn structure 500 may be selected to “blend in” or to complement nearby fibers of the textile where it is woven, knitted or sewn into a fabric, or may be routed through a fabric piping that is incorporated into the textile.

The core 502 of the yarn structure 500 comprises a plurality of electrically conductive wires. As mentioned above, the use of a plurality of conductive wires in the core of a core/sheath yarn may provide for a more flexible structure than a lesser number of thicker wires (e.g. a single thicker wire), and also provides redundant conductive paths in case one of the wires is broken. In some examples, the core includes from three to ten 40-micron diameter copper wires. Each wire 506 may comprise an electrically insulating coating (e.g., an enamel coating), which may avoid shorting of a nearby electrical conductor(s) within the core 502 of the yarn structure 500. In other examples, any suitable number of electrical conductors having any suitable diameter(s) may be used.

In some examples, two or more core/sheath yarn structures may be used for each electrical connection, such as by twisting or otherwise intertwining the two or more core/sheath yarn structures together. In such an example, the intertwined electrically conductive yarns may provide redundancy and failure resistance. In one specific example, two intertwined yarns each includes a core comprising plurality of enamel-coated 40-micron copper wires and also an electrically insulating sheath. Further, two or more different type core/sheath yarn structures may be used for an electrical connection. For example, each core may have a different thickness.

The core 502 of the yarn structure 500 further may comprise a support filament 508 configured to increase a mechanical strength of the core 502. For example, during formation of the yarn sheath, the support filament 508 may help to reduce a pulling force exerted on the electrical conductor(s) 506 and/or may help to shield the electrical conductor(s) 506 from abrasion. The support filament 508 also may help to strengthen the electrically conductive yarn structure for various end uses, such as where the electrically conductive yarn structure is intended to be subject to numerous bending and/or pulling cycles over its lifetime.

The support filament 508 may comprise any suitable material configured to increase the mechanical strength of the core 502. Suitable materials include those that have a high strength-to-size ratio to increase the robustness of the yarn core 502 while not substantially increasing the bulkiness of the yarn structure 500. In one example, the support filament comprises a 280-denier multifilament non-texturized core nylon.

The yarn structure 500 may be fabricated in any suitable manner. In one example, a corespun yarn making machine may be used both to twist together multiple conductive wires in a core and also to spin the sheath 504 around the core 502. An additional step may be used to wind two or more core/sheath yarns together. A twist factor of the yarn structure, which describes the amount of twist given to an individual filament and/or wire as the filament and/or wire is pulled through a yarn making machine, may be adjusted by adjusting the speed of the yarn making machine. Further, yarn cover, which describes the fill of the sheath material, may be adjusted by adjusting the number of rotations per square inch of the sheath material over the yarn structure's core.

FIG. 6 shows an example fabric piping 600 suitable for use as fabric piping 220 of FIGS. 2A and 2B. As shown, fabric piping 600 includes a conduit 602 to accommodate one or more conductive yarn segments. The conduit 602 further may be configured to accommodate some slackness in an electrically conductive yarn to accommodate elongation of the yarn during movement and/or stretching of the textile. Fabric piping 600 may have any suitable structure, such as a hollow braided structure. The hollow braid may be fabricated around the electrically conductive yarn, or the electrically conducive yarn may be pulled through the hollow braid after formation of the hollow braid.

Fabric piping 600 further comprises a seam allowance 606 that may be used to join the fabric piping 600 to a textile. The fabric piping 600 may be joined to the textile in any suitable manner. In one example, the fabric piping 600 is sewn onto a textile, e.g. by sewing the seam allowance 606 into a seam of the textile. In another example, the fabric piping 600 is adhered to a textile.

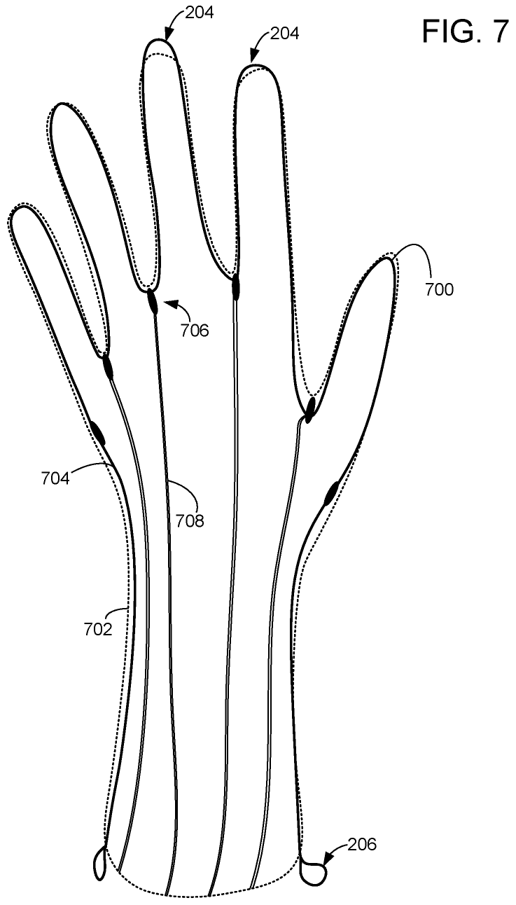

As mentioned above, a textile device may include a force-directing structure configured to distribute a pulling force applied to the textile device, for example when putting on or removing the textile device from the body, to avoid damaging electrical connections within the device. FIG. 7 schematically depicts an example force-directing structure 700 comprising a string 704 extending from a string hook 204 and/or a string hook 206 along an interior fabric layer 702 to a plurality of connection points 706 within the interior of the textile device 106. The string hooks 204, 206 may be attached to a common force-directing structure or to separate force-directing structures. In some examples, a plurality of strings 708 extend from each connection point 706 to further assist distribute the pulling force. In any instance, pulling forces exerted on either of string hooks 204 or 206 are spread across a wider area of an internal structure of the textile device 106. Additionally or alternatively, other suitable force-directing components may be used, such as seam taping and/or more robust seam construction.

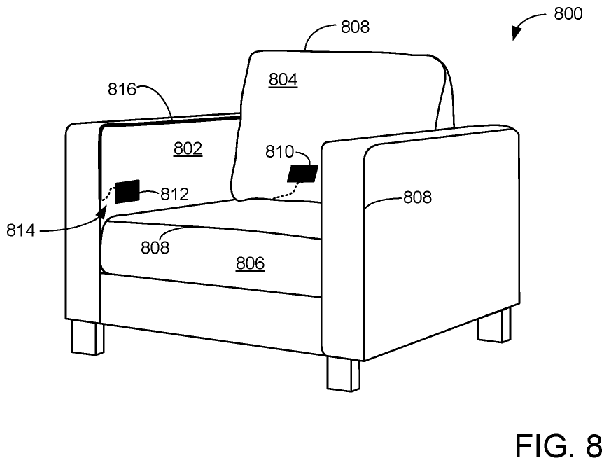

Though described above in the context of a glove-like computer input/output device, the examples disclosed herein may be used with any suitable electronically functional textile article. FIG. 8 depicts an example electronically functional textile article in the form of a reclining chair 800. Chair 800 includes a plurality of upholstered textile structures (e.g. an arm rest 802, a back cushion 804, and a seat cushion 806) that are each trimmed with a decorative fabric piping 808. The chair 800 also includes a sensor 810 coupled with a back hinge of the chair 800, wherein the sensor 810 is electrically connected to a controller 812 disposed on the arm rest side panel 802 via a yarn structure 814 that is positioned within a portion 816 of the fabric piping 808. The yarn structure 814 may comprises one or more segments of the core/sheath yarn structures disclosed herein (e.g., yarn structure 500), or any other suitable electrical conductor.

Another example provides an article comprising a textile, a fabric piping positioned along the textile, an electrical conductor positioned within an interior of the fabric piping, and a first electronic component and a second electronic component disposed on the article and electrically connected by the electrical conductor. In such an example, the electrical conductor may additionally or alternatively comprise a conductive wire within a core of a core/sheath yarn structure. In such an example, the electrical conductor may additionally or alternatively comprise a plurality of conductive wires within the core of the core/sheath yarn structure. In such an example, the conductive wire may additionally or alternatively comprise an electrically insulating coating. In such an example, the core of the core/sheath yarn structure may additionally or alternatively comprise a support filament. In such an example, a sheath of the core/sheath conductive yarn structure may additionally or alternatively comprise an electrically insulating material. In such an example, the electrical conductor may additionally or alternatively be a first electrical conductor, the article may additionally or alternatively comprise a second electrical conductor positioned within the interior of the fabric piping. In such an example, the electrical conductor may additionally or alternatively be connected to the first electronic component via a solder joint. In such an example, the electrical conductor may additionally or alternatively be connected to the first electronic component via a thermoplastic adhesive. In such an example, the fabric piping may additionally or alternatively be one or more of sewn onto the textile and adhered to the textile. In such an example, the article may additionally or alternatively comprise a wearable item.

Another example provides a wearable device comprising a textile, a fabric piping joined to the textile, an electrically conductive yarn structure positioned within an interior of the fabric piping, the electrically conductive yarn structure comprising one or more core/sheath yarns, each core/sheath yarn of the one or more core/sheath yarns comprising an electrical conductor in a core of the core/sheath yarn, and a first electronic component and a second electronic component disposed on the wearable device and electrically connected by the electrically conductive yarn structure. In such an example, the wearable device may additionally or alternatively comprise a glove. In such an example, the first electronic component may additionally or alternatively comprise a circuit board, and wherein the second electronic component may additionally or alternatively comprise a linear resonant actuator motor, an eccentric rotating mass (ERM) motor, a voice coil actuator, a soft actuator, an inertial measurement unit (IMU), a light-emitting diode, a bend sensor, or a pressure sensor. In such an example, the electrically conductive yarn structure may additionally or alternatively be a first electrically conductive yarn structure, and the wearable device may additionally or alternatively comprise a third electronic component, and a second conductive yarn structure positioned within the interior of the fabric piping and connecting to the third electronic component. In such an example, for each core of the one or more core/sheath yarns, the electrical conductor may additionally or alternatively comprise a plurality of conductive wires positioned within the core. In such an example, the wearable device may additionally or alternatively comprise a force-distributing structure coupled with a plurality of locations on the textile and configured to distribute a pulling force applied to the wearable device.

Another example provides an article comprising, a textile, a first electronic component and a second electronic component coupled with the article, and a yarn structure electrically connected to the first electronic component and the second electronic component, the yarn structure comprising a first core/sheath yarn comprising a first plurality of conductive wires within a core of the first core/sheath yarn, and a second core/sheath yarn comprising a second plurality of conductive wires within a core of the second core/sheath yarn. In such an example, the article may additionally or alternatively comprise a fabric piping joined to the textile, and the yarn structure may additionally or alternatively be positioned within the fabric piping. In such an example, the article may additionally or alternatively comprise a support filament within one or more of the core of the first core/sheath yarn and the core of the second core/sheath yarn.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. An article, comprising:
a textile;
a fabric piping positioned along the textile;
an electrical conductor positioned within an interior of the fabric piping; and
a first electronic component and a second electronic component disposed on the article and electrically connected by the electrical conductor.

2. The article of claim 1, wherein the electrical conductor comprises a conductive wire within a core of a core/sheath yarn structure.

3. The article of claim 2, wherein the electrical conductor comprises a plurality of conductive wires within the core of the core/sheath yarn structure.

4. The article of claim 2, wherein the conductive wire comprises an electrically insulating coating.

5. The article of claim 2, wherein the core of the core/sheath yarn structure further comprises a support filament.

6. The article of claim 2, wherein a sheath of the core/sheath conductive yarn structure comprises an electrically insulating material.

7. The article of claim 1, wherein the electrical conductor is a first electrical conductor, the article further comprising a second electrical conductor positioned within the interior of the fabric piping.

8. The article of claim 1, wherein the electrical conductor is connected to the first electronic component via a solder joint.

9. The article of claim 1, wherein the electrical conductor is connected to the first electronic component via a thermoplastic adhesive.

10. The article of claim 1, wherein the fabric piping is one or more of sewn onto the textile and adhered to the textile.

11. The article of claim 1, wherein the article comprises a wearable item.

12. A wearable device, comprising:
a textile;
a fabric piping joined to the textile;
an electrically conductive yarn structure positioned within an interior of the fabric piping, the electrically conductive yarn structure comprising one or more core/sheath yarns, each core/sheath yarn of the one or more core/sheath yarns comprising an electrical conductor in a core of the core/sheath yarn; and
a first electronic component and a second electronic component disposed on the wearable device and electrically connected by the electrically conductive yarn structure.

13. The wearable device of claim 12, wherein the wearable device comprises a glove.

14. The wearable device of claim 12, wherein the first electronic component comprises a circuit board, and wherein the second electronic component comprises a linear resonant actuator motor, an eccentric rotating mass (ERM) motor, a voice coil actuator, a soft actuator, an inertial measurement unit (IMU), a light-emitting diode, a bend sensor, or a pressure sensor.

15. The wearable device of claim 12, wherein the electrically conductive yarn structure is a first electrically conductive yarn structure, and wherein the wearable device further comprises
a third electronic component; and
a second conductive yarn structure positioned within the interior of the fabric piping and connecting to the third electronic component.

16. The wearable device of claim 12, wherein for each core of the one or more core/sheath yarns, the electrical conductor comprises a plurality of conductive wires positioned within the core.

17. The wearable device of claim 12, further comprising a force-distributing structure coupled with a plurality of locations on the textile and configured to distribute a pulling force applied to the wearable device.

18. An article, comprising:
a textile;
a first electronic component and a second electronic component coupled with the article; and
a yarn structure electrically connected to the first electronic component and the second electronic component, the yarn structure comprising
a first core/sheath yarn comprising a first plurality of conductive wires within a core of the first core/sheath yarn, and
a second core/sheath yarn comprising a second plurality of conductive wires within a core of the second core/sheath yarn.

19. The article of claim 18, further comprising a fabric piping joined to the textile, and wherein the yarn structure is positioned within the fabric piping.

20. The article of claim 18, further comprising a support filament within one or more of the core of the first core/sheath yarn and the core of the second core/sheath yarn.
